(19) United States
(12) Patent Application Publication
(10) Pub. No.: US 2026/0043708 A1
(43) Pub. Date: Feb. 12, 2026

(54) ONLINE INSPECTION AND SENSING OF PIPE JOINTS

(71) Applicant: SAUDI ARABIAN OIL COMPANY, Dhahran (SA)

(72) Inventors: Yasser S. ALSUBHI, Dhahran (SA); Slim SOUA, Dhahran (SA)

(73) Assignee: SAUDI ARABIAN OIL COMPANY, Dhahran (SA)

(21) Appl. No.: 18/799,043

(22) Filed: Aug. 9, 2024

(51) Int. Cl. G01M 5/00; F16L 55/00; F16L 101/30

(52) U.S. Cl. CPC G01M 5/0033; F16L 55/00; F16L 2101/30

(57) ABSTRACT

A method of inspecting a pipe joint of a pipeline in active operation includes installing, during or after initial assembly of the pipe joint, a layer of a material comprising graphene, a magnetostrictive material, or a combination thereof in the pipe joint, initiating operation of the pipeline to enable transportation of fluid therethrough, assessing, via one or more sensors provided at or near the layer of the material, symptoms of deterioration and/or anomalies within the pipe joint leading to deterioration of the pipe joint during operation of the pipeline, and designating the pipe joint for repair operations based upon the assessed symptoms of deterioration and/or anomalies within the pipe joint.

### FIELD OF THE DISCLOSURE

The present disclosure relates generally to oil and gas pipeline inspection and, more particularly, to systems and methods for pipe joint inspection during operation.

### BACKGROUND OF THE DISCLOSURE

While assessing material properties or performance of a system, destructive testing can be utilized to determine how the system reacts to varying loads up until, and including, the point of failure for the system. In contrast, non-destructive testing is commonly utilized in the assessment of a system's health without negatively impacting the lifetime of the system of interest. As the name suggests, non-destructive testing enables the testing of material properties and status of the system without damaging or negatively affecting the components of the system. While non-destructive testing can be more expensive and time-consuming than destructive testing, maintaining an active system without damaging or deforming active components is often of greater importance than rapid, simple results.

The use of non-destructive testing within oil and gas operations can be critical to monitoring and maintaining vast, complex systems for extraction, transportation, and refinement of hydrocarbons. These systems can commonly include substantial lengths of pipelines, each formed of a plurality of individual pipe sections mated at pipe joints throughout the pipelines. As some systems can include miles of pipeline, both above ground and buried underground, failure or damage at any pipe location can cause downtime throughout the entire system, and lead to grave material and environmental loss. As such, the non-destructive testing of these pipelines can enable the monitoring of pipeline health for targeted maintenance and reduction of downtime due to failure. While techniques can be utilized for monitoring pipelines during operation using non-destructive testing, conventional non-destructive techniques are only available for pipe joints prior to installation. As such, during the operation of the pipeline and overall system, the pipe joints will be unmonitored and remain a major potential failure location during operation.

Accordingly, systems and methods for monitoring pipe joints using non-destructive testing techniques are desirable.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system for assessing joint integrity of pipelines in operation includes a pipe joint within a pipeline in operation, a layer of a material integrated within the pipe joint of the pipeline, the material comprising graphene, a magnetostrictive material, or a combination thereof, and one or more sensors provided at or near the pipe joint and/or the layer of the material and operable to detect deterioration of the pipe joint during operation. The sensors are operable to detect symptoms of deterioration of the pipe joint and/or anomalies within the pipe joint leading to deterioration.

In another embodiment, a method of inspecting a pipe joint of a pipeline in active operation includes installing, during or after initial assembly of the pipe joint, a layer of a material comprising graphene, a magnetostrictive material, or a combination thereof in the pipe joint, initiating operation of the pipeline to enable transportation of fluid therethrough, assessing, via one or more sensors provided at or near the layer of the material, symptoms of deterioration and/or anomalies within the pipe joint leading to deterioration of the pipe joint during operation of the pipeline, and designating the pipe joint for repair operations based upon the assessed symptoms of deterioration and/or anomalies within the pipe joint.

In a further embodiment, a system for assessing a joint integrity of a pipe joint within a pipeline in active operation includes a layer of a material integrated within the pipe joint of the pipeline, the layer of the material comprising graphene, a magnetostrictive material, or a combination thereof, and a pigging robot operable to detect changes in the layer of the material from within an interior flowpath of the pipeline. The pigging robot includes traversal means for navigating the pigging robot through the interior flowpath of the pipeline, and one or more sensors included on the pigging robot and operable to detect deterioration of the pipe joint during operation, wherein the sensors of the pigging robot are operable to detect symptoms of deterioration of the pipe joint and/or anomalies within the pipe joint leading to deterioration.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A is a schematic side view of a pipe joint with a layer of a material installed for monitoring the pipe joint in operation, according to an embodiment consistent with the present disclosure.

FIG. 1B is a schematic side view of a pipe joint with an alternate layer of the material installed for monitoring the pipe joint during operation, according to an embodiment consistent with the present disclosure.

FIG. 2A is a schematic side view of a system for monitoring of the pipe joint using integrated sensing means, according to an embodiment consistent with the present disclosure.

FIG. 2B is a schematic side view of a system for monitoring of the pipe joint using an inline inspection robot, according to an embodiment consistent with the present disclosure.

FIG. 3 is an example method for monitoring a pipe joint in operation via an installed layer of a material, according to one or more embodiments consistent with the present disclosure.

FIG. 4 illustrates one example of a computer system that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to oil and gas pipeline inspection and, more particularly, to systems and methods for pipe joint inspection during operation. The systems and methods disclosed herein can enable monitoring and assessment of previously inaccessible pipe joints within expansive pipelines. The disclosed embodiments can enable non-destructive testing of pipe joints formed of reinforced thermosetting resin pipes commonly used in the transportation of hydrocarbons. Through the monitoring and assessment of degradation within the pipe joints, the disclosed embodiments can reduce system failures due to pipe joint failures, and can provide advanced warning of deteriorating pipe joints prior to failure. The disclosed embodiments can combine active graphene and/or magnetostrictive materials with sensors deployed on a pigging robot or external interrogation tool to perform the damage assessment. The disclosed embodiments can capture signs of a variety of deterioration and damage events via the pigging robot or external interrogation tool, and can be deployed within buried, or otherwise inaccessible, pipelines and pipe joints. The selection of an installed layer of material and provided sensors can further enable the tuning of the disclosed embodiments to a wide variety of applications and environments.

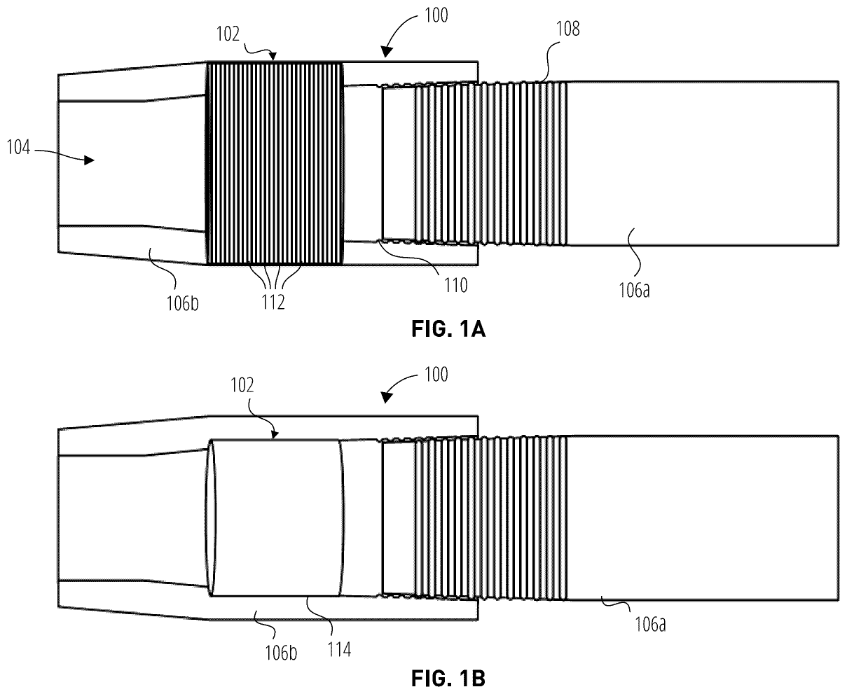

FIG. 1A is a schematic side view of a pipe joint 100 with a layer of material 102 installed for monitoring the pipe joint 100 in operation, according to an embodiment consistent with the present disclosure. In some embodiments, the pipe joint 100 can be included within a larger pipeline system for an oil and gas extraction or transportation operation. In these embodiments, the pipe joint 100 and any constituent pipes of the pipeline can be reinforced thermosetting resin pipes formed of a nonmetallic material. These reinforced thermosetting resin pipes can be commonly tested using non-destructive testing to determine asset integrity and any needed maintenance. However, the joints of the reinforced thermosetting resin pipes, such as the pipe joint 100, lack conventional means for non-destructive testing, particularly during operation of the pipeline. As such, the layer of material 102 can be installed within an interior flowpath 104 of the pipe joint 100 to enable non-destructive testing thereof.

The layer of material 102 can comprise a graphene, one or more magnetostrictive materials (e.g. Terfenol-D or Galfenol), or a combination thereof. The layer of material 102 can accordingly include material properties preferable for sensing stresses and conducting electricity for a variety of applied uses. The inclusion of the layer of material 102 can enable direct sensing of magnetic fields, pressures, stresses, and strains within the pipe joint 100, and conduction of electricity and electrical signals, while further providing structural reinforcement to the pipe joint 100. The selected material and material properties of the layer of material 102 within the pipe joint 100 can be chosen based upon the desired sensing operations to be performed, as well as the desired integration within the pipe joint 100, such that the structural integrity of the pipe joint 100 and pipeline are not adversely affected.

In the illustrated embodiment, the pipe joint 100 can include a first pipe segment 106a and a second pipe segment 106b to be mated at the pipe joint 100. The first pipe segment 106a and the second pipe segment 106b can be mated at the pipe joint 100 to provide a unified interior flowpath 104 therethrough, such that fluids can be transported through the pipe joint 100 during operation. The first pipe segment 106a and second pipe segment 106b can include mating means for the connection of the two segments at the pipe joint 100. In the illustrated embodiment, the first pipe segment 106a includes a threaded insert 108 that can be received within a threaded receiver 110 of the second pipe segment 106b, such that the pipe joint 100 is formed between the two segments. It should be noted, however, that any such mating means, such as laminate, flange, and adhesive mating, can be included in the pipe joint 100 without departing from the scope of this disclosure.

Further in the illustrated embodiment, the layer of material 102 is integrally formed within the pipe joint 100 during the manufacturing of the second pipe segment 106b or the pipe joint 100. In some embodiments, the layer of material 102 can be formed of a plurality of filaments 112 arranged in a desired configuration to form the layer of material 102 within the pipe joint 100. The filaments 112 can be wires or fibers of the disclosed materials, and can be embedded within a resin matrix of the second pipe segment 106b or the pipe joint 100 during formation. As such, the filaments 112 can be integrally formed into the pipe joint 100, such that any damage or changes to the pipe joint 100 can be sensed via the filaments 112. The filaments 112 can be arranged in various orientations within the pipe joint 100, such that the layer of material 102 can sense variations with directional sensitivity, thus optimizing sensing performance within the pipe joint 100. Alternatively, in further embodiments, the layer of material 102 of the illustrated embodiment can be formed of a plurality of powder particulates included within the pipe joint 100 or second pipe segment 106b during formation, such that a homogenous distribution of the layer of material 102 can be achieved within the pipe joint 100. The use of powder particulates can enable a wide-spread sensing capability within the pipe joint 100, to the extent that the powder particulates were distributed during the formation process, while similarly enabling multi-directional sensing.

FIG. 1B is a schematic side view of a pipe joint 100 with an alternate layer of material 102 installed for monitoring the pipe joint 100 during operation, according to an embodiment consistent with the present disclosure. In the illustrated embodiment, the alternate layer of material 102 can comprise a single sheet 114 of the material (graphene and/or magnetostrictive material). In some embodiments, the single sheet 114 can be a thin sheet or plate of the material that can be similarly integrated into the pipe joint 100 or second pipe segment 106b. Alternatively, the thin sheet or plate of the single sheet 114 can be mounted to an interior or exterior of the pipe joint 100 or second pipe segment 106b, such that the single sheet 114 can monitor changes to the pipe joint 100 during operation. The thin sheet or plate of the material can provide uniform coverage of the pipe joint 100, and can consistently respond to applied magnetic fields or stresses. In a further embodiment, the single sheet 114 can be a blanket or film of the material that can be adhered to a surface of the pipe joint 100, either internally or externally. The blanket or film of material of single sheet 114 can provide flexibility of placement on or around the pipe joint 100, and can adapt to various geometries that can be present within the pipe joint 100. The use of a blanket or film as the single sheet 114 can enable a large coverage area within the pipe joint 100, such that the layer of material 102 provides comprehensive sensing coverage within the pipe joint 100.

Regardless of the form the layer of material 102 can utilize, the layer of material 102 can provide varied and robust sensing of deterioration of the pipe joint 100. Layers of material 102 formed of graphene and/or magnetostrictive materials can be monitored for changes in strain or magnetic properties that can directly denote cracking, delamination, environmental damage causing dimensional changes, fatigue damage, impact damage, and manufacturing defects of the pipe joint 100. Further, the layers of material 102 can indirectly sense fiber breakage, chemical degradation, and joint failure, through the detection of structural changes, the overall strain response, mechanical weakening, and magnetic field variations. In some embodiments, graphene can be chosen for the layer of material 102 for a piezoresistive effect, chemical sensing, and temperature sensing, and can be highly sensitive to changes in mechanical strain of the pipe joint 100. In these embodiments, graphene can be used for multi-parameter sensing systems, such that the layer of material 102 can detect changes in chemical, thermal, and mechanical properties of the pipe joint 100. In further embodiments, magnetostrictive materials can be chosen for the layer of material 102 for detecting changes in shape or dimensions of the pipe joint 100 in response to an applied magnetic field, and can provide reliable mechanical damage sensing. Due to the various differences in properties of the possible materials for the layer of material 102, the selection of a desirable material for the layer of material 102 can depend upon the application and manufacturing of the pipe joint 100.

Further, the changes in the layers of material 102 can be used in sensing anomalies within the pipe joint 100 that lead to deterioration of the pipe joint 100, as well as the symptoms of deterioration within the pipe joint 100. The anomalies that can be detected via changes in the layers of material 102 can include, but are not limited to, misalignment before and during installation of the pipe joint 100, incorrect assembly of the pipe joint 100, mis-handling of the pipe joint 100 during transport and storage, damaged threads of the pipe joint 100, over-torquing and over-bending of the pipe joint 100, and external loading of the pipe joint 100 due to external forces, pressures, and temperature variations. In addition to the symptoms of deterioration discussed above, the symptoms of deterioration can further include, but are not limited to, delamination, disbanding, leaks through laminate of the pipe joint 100, cracking, voids or gaps inside of the pipe joint 100, air bubbles, incomplete contact, lack of adhesion, changes in thickness, physical changes due to chemical degradation, and damage due to moisture or other liquid contamination.

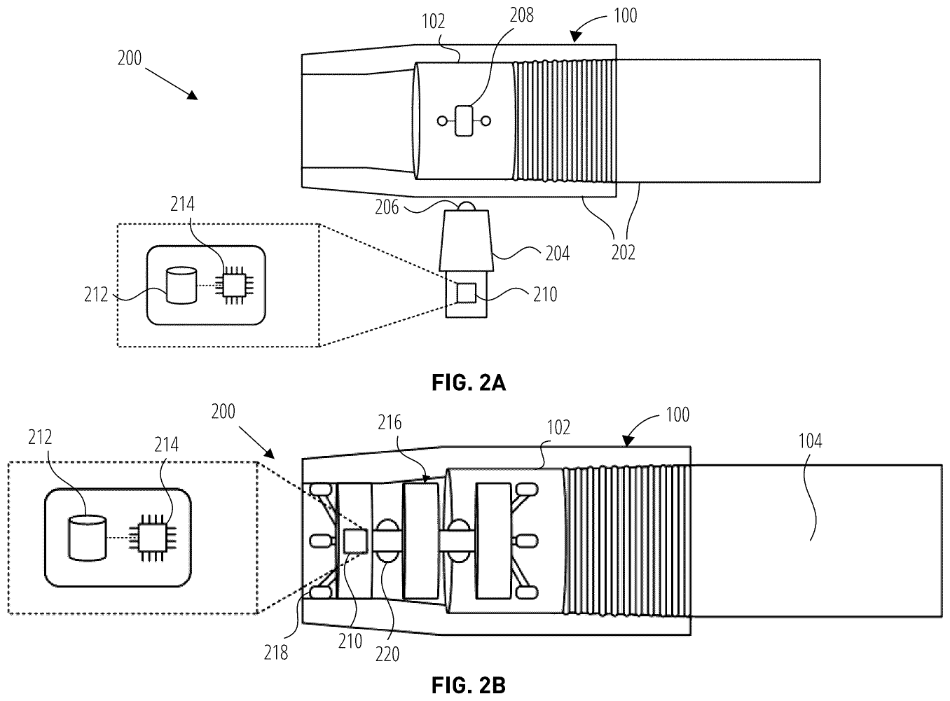

FIG. 2A is a schematic side view of a system 200 for monitoring of the pipe joint 100 using externally deployed sensing means, according to an embodiment consistent with the present disclosure. The system 200 can include a layer of material 102 installed within the pipe joint 100 at an interface between the mated pipe segments 202. In the illustrated embodiment, the layer of material 102 extends along a portion of the pipe joint 100, however, in further embodiments the layer of material 102 can extend along an entire length of the pipe joint 100 for broad sensing capabilities. With an installed layer of material 102 and mated pipe segments 202, the system 200 can include a plurality of varying sensors at or near the layer of material 102 for performance of the sensing within the layer of material 102.

In some embodiments, the system 200 can include an external interrogation tool 204 that can be provided or advanced at or near the pipe joint 100. The external interrogation tool 204 can include one or more tool sensors 206 that can detect changes within the layer of material 102 during an assessment of the pipe joint 100. In further embodiments, the system 200 can include one or more external sensors 208 mounted to an exterior of the pipe joint 100, wrapped therearound, or otherwise near the pipe joint 100. As an example, the external sensor 208 can be a non-contact impedance transducer applied onto the exterior of the pipe joint 100 to detect changes within the layer of material 102 and pipe joint 100. Further external sensors 208 could be chosen from fiber optic or piezoresistive sensors for the detection of changes or deformations within the pipe joint 100 and layer of material 102. Both the tool sensors 206 and external sensors 208 can be selected based upon the chosen material of the layer of material 102, as well as the application of the pipe joint 100. In alternate embodiments, the external sensors 208 can be further integrated directly into the pipe joint 100 or the layer of material 102, such that an integrated sensor may be provided for constant monitoring of the pipe joint 100.

In some embodiments, the tool sensors 206 and external sensors 208 can include magnetostrictive sensors, which can include coils wrapped around the pipe joint 100 or layer of material 102 to apply a magnetic field to any magnetostrictive materials and detect changes in lengths, impedances, or magnetic properties of the layer of material 102. Further, the tool sensors 206 and external sensors 208 can include magnetic field sensors operable to measure changes in the magnetic field around any magnetostrictive materials, and can include Hall effect sensors, magnetoresistive sensors, and fluxgate magnetometers. In further embodiments, acoustic sensors can be included within the system 200, such as ultrasonic transducers and piezoelectric sensors, which can detect and analyze acoustic waves propagating from the layer of material 102. Further changes in the pipe joint 100 and layer of material 102 can be detected using temperature sensors and electrical conductivity sensors that can monitor variations in thermal and electrical properties of the pipe joint 100 and layer of material 102 during operation. The use of these tool sensors 206 and external sensors 208 in combination with the layer of material 102 can enable monitoring and assessment of the layer of material 102, thus enabling the same monitoring and assessment of the pipe joint 100 with which the layer of material 102 is integrated.

In some embodiments, the external interrogation tool 204 can include a controller 210 for enabling interrogation of the pipe joint 100 and layer of material 102, as well as storing sensor readings and other data. As such, the controller 210 can include a memory 212 therein, which can store the signals provided from the tool sensors 206 or any connected external sensors 208, as well as any programs or modules operable to convert the received signals into physical parameters and integrity of the layer of material 102 and pipe joint 100. The controller 210 can further include a processor 214 coupled to the memory 212, and can be operable to perform analysis and conversion of the received signals using the programs or modules stored in the memory 212. The controller 210 can enable an operator to view the characteristics and integrity of the pipe joint 100 and layer of material 102, such that the operator can monitor the health of the pipe joint 100 with the external interrogation tool 204. In further embodiments, however, the controller 210 may provide programs for operating the tool sensors 206 and storage for raw readings of the tool sensors 206 without on-board analysis or conversion modules.

FIG. 2B is a schematic side view of a system 200 for monitoring of the pipe joint 100 using a pigging robot 216, according to an embodiment consistent with the present disclosure. The pigging robot 216 can be inserted within the interior flowpath 104 of the pipeline, and can be advanced through the pipeline until reaching an area at or near the layer of material 102 and pipe joint 100. The pigging robot 216 can include traversal means 218, such as the motorized wheels of the illustrated embodiment, such that the pigging robot 216 can traverse the pipeline to reach the desired location. Upon reaching the desired location, the pigging robot 216 can utilize a plurality of included sensors 220 to perform sensing and analysis of the pipe joint 100 and layer of material 102. The included sensors 220 can be selected from any of the above-discussed sensors, including, but not limited to, magnetostrictive sensors, magnetic field sensors, impedance sensors, acoustic sensors, temperature sensors, and electrical conductivity sensors. In some embodiments, the pigging robot 216 may be alternately referenced as a crawler, pig, robot, or inspection robot.

The pigging robot 216 can further include an on-board controller 210, similar to the embodiments of the external interrogation tool 204 illustrated in FIG. 2A. In some embodiments, the pigging robot 216 can further include battery or energy-harvesting technology for powering the pigging robot 216, navigation and control systems for traversing the pipeline to reach the desired location while logging the position of the pigging robot 216, interrogation of the layer of material 102 and the pipe joint 100, and data logging thereof, along with a robust construction for surviving possible caustic environments within the pipeline. In some embodiments, the pigging robot 216 can be a custom-made robot operable to only detect changes within the pipe joint 100 and layer of material 102.

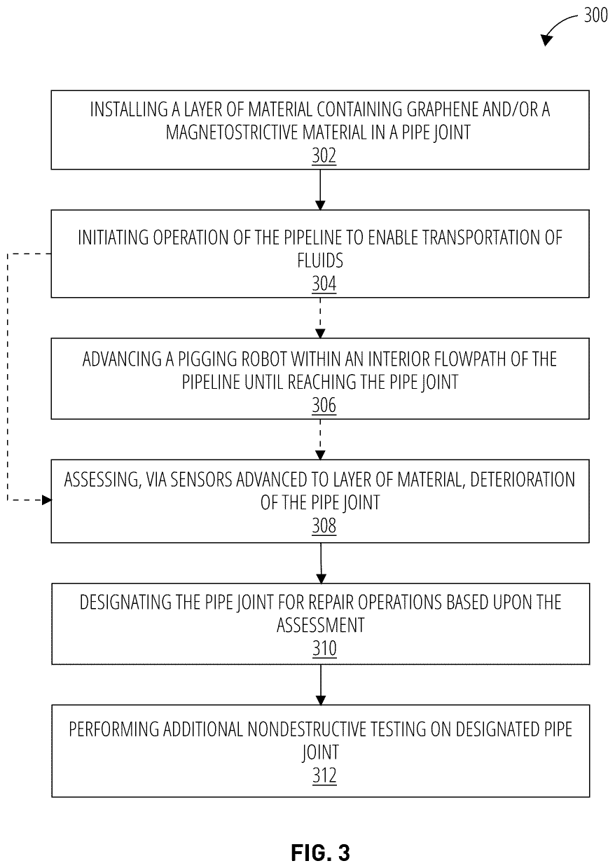

In view of the structural and functional features described above, example methods will be better appreciated with reference to FIG. 3. While, for purposes of simplicity of explanation, the example methods of FIG. 3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description. Further, the method 300 can be implemented by the system 200, as shown in FIGS. 2A-2B. Thus, reference can be made to the example of FIGS. 1-2B in the example of FIG. 3.

FIG. 3 is an example method 300 for assessing a pipe joint in operation via an installed layer of a material, according to one or more embodiments consistent with the present disclosure. The method 300 can begin at 302 with installing a layer of a material (e.g., the layer of material 102) comprising graphene, a magnetostrictive material, or a combination thereof in a pipe joint (e.g., the pipe joint 100) of a pipeline. In some embodiments, the pipeline can be an oil and gas pipeline utilized in the extraction and/or transport of hydrocarbons. In further embodiments, the pipeline and pipe joint are reinforced thermosetting resin pipes, such that the layer of the material is installed to enable monitoring of the pipe joint during operation. The installation of the layer of the material at 302 can be performed during or after initial assembly of the pipe joint, such that the layer of the material can be formed of embedded powder particulates or filaments, or can be an applied patch of the material in a single sheet or thin film.

The method 300 can continue at 304 with initiating operation of the pipeline to enable transportation of fluids therethrough, such that the pipe joint is utilized in operation of the pipeline. The method 300 can enable monitoring and assessment of the pipe joint during this operation, such that any damage or imperfections of the pipe joint can be detected and remedied. In some embodiments, the method 300 can further include advancing a pigging robot (e.g., the pigging robot 216) within an interior flowpath (e.g., the interior flowpath 104) of the pipeline until reaching the pipe joint. In these embodiments, the pigging robot can include at least one included sensor (e.g., the included sensors 220) to monitor and assess deterioration of the pipe joint.

The method 300 can further include assessing, via one or more sensors (e.g., the tool sensors 206, external sensors 208, and/or included sensors 220) included at or near the layer of the material, any deterioration of the pipe joint during operation of the pipeline at 308. In embodiments in which a pigging robot is advanced through the pipeline, the included sensors of the pigging robot can be utilized in the monitoring and assessment at 308. In alternate embodiments, however, an external interrogation tool (e.g., the external interrogation tool 204) can be provided or advanced to the pipe joint for interrogation of the layer of material to assess damage of the pipe joint. The method 300 can continue at 310 with designating the pipe joint for repair operations (including replacement), based upon the assessed deterioration of the pipe joint. Using the assessed deterioration, the operator can determine if the deterioration of the pipe joint and the layer of the material reach a level at which repair operations are to be performed. In further embodiments, however, the designation at 310 can be made autonomously by a controller (e.g., the controller 210) based upon pre-defined thresholds or the presence of specific damage. In some embodiments, the method 300 can continue at 312 with performing additional non-destructive testing, visual inspection, or a combination thereof on a designated pipe joint prior to the performance of repair operations. In these embodiments, the initial assessment of deterioration via the system can be used to signal possible damage and pipe joints of interest. The further testing at 312 can be accordingly utilized in validating the remote sensing of the layer of the material, and can be used in tuning a behavior of the layer of the material. In some embodiments, the pipeline can be buried underground or otherwise inaccessible, such that the method 300 further includes excavating the pipe joint for further testing or repair operations (including replacement). In these embodiments, the sensing and monitoring of the inaccessible pipe joints can provide valuable insights on the inaccessible assets.

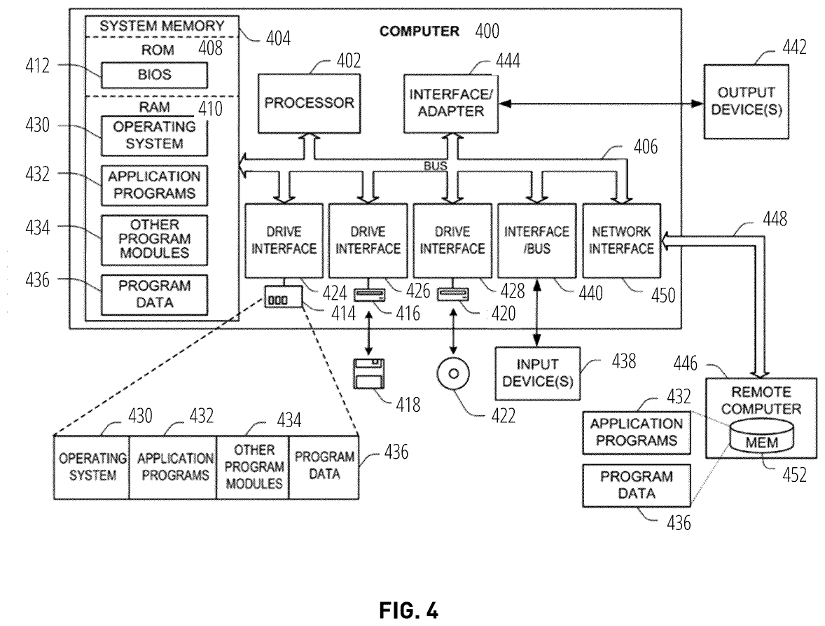

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S. C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. System memory 404 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 408 and random-access memory (RAM) 410. A basic input/output system (BIOS) 412 can reside in ROM 408 containing the basic routines that help to transfer information among elements within computer system 400.

Computer system 400 can include a hard disk drive 414, magnetic disk drive 416, e.g., to read from or write to removable disk 418, and an optical disk drive 420, e.g., for reading CD-ROM disk 422 or to read from or write to other optical media. Hard disk drive 414, magnetic disk drive 416, and optical disk drive 420 are connected to system bus 406 by a hard disk drive interface 424, a magnetic disk drive interface 426, and an optical drive interface 428, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and ROM 408, including operating system 430, one or more application programs 432, other program modules 434, and program data 436. In some examples, the application programs 432 can include modules and programs for signal processing of the received signals, deterioration assessment modules, and display modules for visualizing material properties to an operator, and the program data 436 can include any of the sensor readings, the provided signals, the material properties of the pipe joint 100 and layer of material 102, and control data for the pigging robot 216. The application programs 432 and program data 436 can include functions and methods programmed to enable monitoring and assessment of pipe joints in operation, particularly within reinforced thermosetting resin pipes, such as shown and described herein.

A user may enter commands and information into computer system 400 through one or more input device 438, such as a pointing device (e.g., a mouse, touch screen), keyboard, microphone, joystick, game pad, scanner, and the like. For instance, the user can employ input device 438 to edit or modify deterioration thresholds, motion of the pigging robot 216, applied magnetic fields, and other tunable parameters of the system 200. These and other input devices 438 are often connected to processing unit 402 through a corresponding port interface 440 that is coupled to the system bus, but may be connected by other interfaces, such as a parallel port, serial port, or universal serial bus (USB). One or more output devices 442 (e.g., display, a monitor, printer, projector, or other type of displaying device) is also connected to system bus 406 via interface 444, such as a video adapter.

Computer system 400 may operate in a networked environment using logical connections to one or more remote computers, such as remote computer 446. Remote computer 446 may be a workstation, computer system, router, peer device, or other common network node, and typically includes many or all the elements described relative to computer system 400. The logical connections, schematically indicated at 448, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 400 can be connected to the local network through a network interface or adapter 450. When used in a WAN networking environment, computer system 400 can include a modem, or can be connected to a communications server on the LAN. The modem, which may be internal or external, can be connected to system bus 406 via an appropriate port interface. In a networked environment, application programs 432 or program data 436 depicted relative to computer system 400, or portions thereof, may be stored in a remote memory storage device 452.

Embodiments disclosed herein include:

A. A system for assessing joint integrity of pipelines in operation comprising a pipe joint within a pipeline in operation, a layer of a material integrated within the pipe joint of the pipeline, the material comprising graphene, a magnetostrictive material, or a combination thereof, and one or more sensors provided at or near the pipe joint and/or the layer of the material and operable to detect deterioration of the pipe joint during operation, wherein the sensors are operable to detect changes in the layer of the material indicating symptoms of deterioration of the pipe joint and/or anomalies within the pipe joint.

B. A method of inspecting a pipe joint of a pipeline in active operation comprising installing, during or after initial assembly of the pipe joint, a layer of a material comprising graphene, a magnetostrictive material, or a combination thereof in the pipe joint, initiating operation of the pipeline to enable transportation of fluid therethrough, assessing, via one or more sensors provided at or near the layer of the material, changes in the layer of the material indicating symptoms of deterioration and/or anomalies within the pipe joint leading to deterioration of the pipe joint during operation of the pipeline, and designating the pipe joint for repair operations based upon the assessed symptoms of deterioration and/or anomalies within the pipe joint.

C. A system for assessing a joint integrity of a pipe joint within a pipeline in active operation comprising a layer of a material integrated within the pipe joint of the pipeline, the layer of the material comprising graphene, a magnetostrictive material, or a combination thereof, and a pigging robot operable to detect changes in the layer of the material from within an interior flowpath of the pipeline, the pigging robot including traversal means for navigating the pigging robot through the interior flowpath of the pipeline, and one or more sensors included on the pigging robot and operable to detect deterioration of the pipe joint during operation, wherein the sensors of the pigging robot are operable to detect the changes in the layer of the material indicating symptoms of deterioration of the pipe joint and/or anomalies within the pipe joint leading to deterioration.

Each of embodiments A through C may have one or more of the following additional elements in any combination: Element 1: wherein the sensors are selected from the group consisting of magnetostrictive sensors, magnetic field sensors, impedance sensors, acoustic sensors, temperature sensors, and electrical conductivity sensors, and any combination thereof. Element 2: wherein the pipeline and the pipe joint include reinforced thermosetting resin pipes in active operation. Element 3: wherein the layer of the material is formed of a powder distributed throughout a resin matrix of the reinforced thermosetting resin pipe. Element 4: wherein the pipeline and the pipe joint are buried or otherwise inaccessible to an operator. Element 5: wherein the layer of the material is formed of a single layer of the material as a sheet, a plate, a film, or a blanket integrated into a structure of the pipe joint. Element 6: wherein the layer of the material includes a plurality of filaments integrated at various orientations and providing directional sensitivity. Element 7: further comprising an external interrogation tool provided or advanced to the pipe joint and operable to use one or more tool sensors to assess deterioration of the later of the material and/or the pipe joint. Element 8: wherein the pipe joint and the pipeline include reinforced thermosetting resin pipes formed of a resin matrix. Element 9: further comprising: advancing a pigging robot within an interior flowpath of the pipeline until reaching the pipe joint, wherein at least one of the one or more sensors are included sensors on the pigging robot.

Element 10: wherein the layer of the material is selected from the group consisting of a plurality of filaments, a sheet, a thin film, and a combination thereof. Element 11: wherein the one or more sensors are provided on an external interrogation tool advanced or provided at or near the pipe joint and operable to interrogate a status of the layer of the material and/or the pipe joint. Element 12: wherein the pipeline is buried underground, and wherein the method further comprises excavating the pipe joint for repair operations. Element 13: further comprising: performing additional non-destructive testing, visual inspection, or a combination thereof on a designated pipe joint. Element 14: wherein the sensors are selected from the group consisting of magnetostrictive sensors, magnetic field sensors, impedance sensors, acoustic sensors, temperature sensors, and electrical conductivity sensors, and any combination thereof. Element 15: wherein the pipeline and the pipe joint include reinforced thermosetting resin pipes in operation. Element 16: wherein the pipeline and the pipe joint are buried or otherwise inaccessible to an operator. Element 17: wherein the pigging robot further comprises: a controller operable to control traversal, interrogation, and data logging of the pigging robot while deployed within the pipeline.

By way of non-limiting example, exemplary combinations applicable to A through C include: Element 2 with Element 3; Element 2 with Element 4; Element 12 with Element 13; and Element 15 with Element 16.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second. ” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system for assessing joint integrity of pipelines in operation, the system comprising:
a pipe joint within a pipeline in operation;
a layer of a material integrated within the pipe joint of the pipeline, the material comprising graphene, a magnetostrictive material, or a combination thereof; and
one or more sensors provided at or near the pipe joint and/or the layer of the material and operable to detect deterioration of the pipe joint during operation,
wherein the sensors are operable to detect changes in the layer of the material indicating symptoms of deterioration of the pipe joint and/or anomalies within the pipe joint.

2. The system of claim 1, wherein the sensors are selected from the group consisting of magnetostrictive sensors, magnetic field sensors, impedance sensors, acoustic sensors, temperature sensors, and electrical conductivity sensors, and any combination thereof.

3. The system of claim 1, wherein the pipeline and the pipe joint include reinforced thermosetting resin pipes in active operation.

4. The system of claim 3, wherein the layer of the material is formed of a powder distributed throughout a resin matrix of the reinforced thermosetting resin pipe.

5. The system of claim 3, wherein the pipeline and the pipe joint are buried or otherwise inaccessible to an operator.

6. The system of claim 1, wherein the layer of the material is formed of a single layer of the material as a sheet, a plate, a film, or a blanket integrated into a structure of the pipe joint.

7. The system of claim 1, wherein the layer of the material includes a plurality of filaments integrated at various orientations and providing directional sensitivity.

8. The system of claim 1, further comprising an external interrogation tool provided or advanced to the pipe joint and operable to use one or more tool sensors to assess deterioration of the later of the material and/or the pipe joint.

9. A method of inspecting a pipe joint of a pipeline in active operation, the method comprising:
installing, during or after initial assembly of the pipe joint, a layer of a material comprising graphene, a magnetostrictive material, or a combination thereof in the pipe joint;
initiating operation of the pipeline to enable transportation of fluid therethrough;
assessing, via one or more sensors provided at or near the layer of the material, changes in the layer of the material indicating symptoms of deterioration and/or anomalies within the pipe joint leading to deterioration of the pipe joint during operation of the pipeline; and
designating the pipe joint for repair operations based upon the assessed symptoms of deterioration and/or anomalies within the pipe joint.

10. The method of claim 9, wherein the pipe joint and the pipeline include reinforced thermosetting resin pipes formed of a resin matrix.

11. The method of claim 9, further comprising:
advancing a pigging robot within an interior flowpath of the pipeline until reaching the pipe joint,
wherein at least one of the one or more sensors are included sensors on the pigging robot.

12. The method of claim 9, wherein the layer of the material is selected from the group consisting of a plurality of filaments, a sheet, a thin film, and a combination thereof.

13. The method of claim 9, wherein the one or more sensors are provided on an external interrogation tool advanced or provided at or near the pipe joint and operable to interrogate a status of the layer of the material and/or the pipe joint.

14. The method of claim 9, wherein the pipeline is buried underground, and wherein the method further comprises excavating the pipe joint for repair operations.

15. The method of claim 14, further comprising:
performing additional non-destructive testing, visual inspection, or a combination thereof on a designated pipe joint.

16. A system for assessing a joint integrity of a pipe joint within a pipeline in active operation, the system comprising:
a layer of a material integrated within the pipe joint of the pipeline, the layer of the material comprising graphene, a magnetostrictive material, or a combination thereof; and
a pigging robot operable to detect changes in the layer of the material from within an interior flowpath of the pipeline, the pigging robot including:
traversal means for navigating the pigging robot through the interior flowpath of the pipeline, and
one or more sensors included on the pigging robot and operable to detect deterioration of the pipe joint during operation,
wherein the sensors of the pigging robot are operable to detect the changes in the layer of the material indicating symptoms of deterioration of the pipe joint and/or anomalies within the pipe joint leading to deterioration.

17. The system of claim 16, wherein the sensors are selected from the group consisting of magnetostrictive sensors, magnetic field sensors, impedance sensors, acoustic sensors, temperature sensors, and electrical conductivity sensors, and any combination thereof.

18. The system of claim 16, wherein the pipeline and the pipe joint include reinforced thermosetting resin pipes in operation.

19. The system of claim 18, wherein the pipeline and the pipe joint are buried or otherwise inaccessible to an operator.

20. The system of claim 16, wherein the pigging robot further comprises:
a controller operable to control traversal, interrogation, and data logging of the pigging robot while deployed within the pipeline.
